(19) United States
(12) Patent Application Publication
(10) Pub. No.: US 2011/0122317 A1
(43) Pub. Date: May 26, 2011

(54) CONTROL METHOD OF PROMPT FACILITY IN HDMI-CEC DEVICE AND DISPLAY APPARATUS WITH SUCH CONTROL METHOD

(75) Inventor: Shun-Yi Chen, Taoyuan County (TW)

(73) Assignee: NOVATEK MICROELECTRONICS CORP., Hsinchu (TW)

(21) Appl. No.: 12/784,480

(22) Filed: May 20, 2010

(30) Foreign Application Priority Data
Nov. 25, 2009 (TW) 98140206

(51) Int. Cl. H04N 5/445; H04N 7/16; H04N 5/44

(52) U.S. Cl. 348/563; 725/153; 348/734; 348/E05.103

(57) ABSTRACT

A displaying apparatus with prompt facility in HDMI-CEC device includes a control unit, a display panel and a HDMI signal processing unit. The control unit can receive a control signal generated from a remote controller. The display panel is controlled by the control unit to display an image. The HDMI signal processing unit is coupled with the control unit and coupled with at least one peripheral apparatus, which also has the HDMI-CEC facility. When the remote controller controls the peripheral apparatus via the control unit and the HDMI signal processing unit, the image of the display panel can show a set of functional-key prompting pattern in the remote controller, corresponding to the peripheral apparatus.

### CROSS-REFERENCE TO RELATED APPLICATION

This application claims the priority benefit of Taiwan application serial no. 98140206, filed on Nov. 25, 2009. The entirety of the above-mentioned patent application is hereby incorporated by reference herein and made a part of specification.

### BACKGROUND OF THE INVENTION

1. Field of the Invention

The invention relates to a control technology applied to a display apparatus having HDMI-CEC prompt facility. More particularly, the invention relates to a control method with prompt facility of functional keys.

2. Description of Related Art

In general, home video devices and audio devices are coupled to televisions to simultaneously or separately play video and audio files, and complete audio-visual effects can then be accomplished.

FIG. 1 is a schematic view illustrating a conventional audio-visual combo. As indicated in FIG. 1, the television 100, a common audio-visual equipment, is conventionally coupled to other apparatuses for extending audio and visual applications. For instance, the television 100 can be coupled to a DVD player 102, an audio amplifier 104, a recorder 106, or any other possible peripheral apparatus 108.

In FIG. 1, the television 100 and the peripheral apparatuses connected thereto each have a remote controller to control individual apparatus according to the related art. The multiple remote controllers result in inconvenient use.

With development of various technologies, a one-screen display (OSD) technique is proposed at first. By applying the OSD technique, multiple apparatuses coupled to one another can be easily controlled through the same screen, e.g. the same television screen. Later, based on the OSD technique, a control technique named HDMI-CEC is proposed as well. HDMI refers to high definition multimedia interface, and CEC stands for consumer electronics control. When the television is equipped with the HDMI-CEC facility, the television can be coupled to the consumer electronics with the HDMI-CEC facility.

FIG. 2 is a schematic view illustrating control of connection between a conventional television with HDMI-CEC facility and peripheral apparatuses. As indicated in FIG. 2, the television 200 with the HDMI-CEC facility can be coupled to external peripheral apparatuses 122, 124, and 126 that also have the HDMI-CEC facility. In this case, only one remote controller 128 is required to control the desired peripheral apparatuses by the OSD of the television 120. Namely, the peripheral apparatuses can be controlled by the same remote controller 128 and the same television 120.

However, when a user selects to switch the television 120 to the peripheral apparatuses 122, 124, and 126, the setting of functional keys with the HDMI-CEC facility is rather time consuming, given the user is not aware of setting the functional keys with the HDMI-CEC facility. That is because a lot of keys are on the remote controller 128. When the user switches the television 120 to the peripheral apparatuses 122, 124, and 126 having the HDMI-CEC facility, such as the DVD player, the audio amplifier, the recorder, or the set-top box (STB), the user does not know the corresponding functional keys. Further, the keys on the apparatuses having the HDMI-CEC facility may correspond to different functions. Therefore, the user often needs to press the keys one by one in order to learn the function corresponding to each key, which is rather inconvenient.

Although the remote controller can integrate the control of the HDMI-CEC facility, multiple keys corresponding to different functions complicate the use of the apparatuses. How to integrate the control of the HDMI-CEC facility in a simple manner is thus important.

### SUMMARY OF THE INVENTION

The invention is directed to a display apparatus with HDMI-CEC prompt facility and a control method applied to the display apparatus, such that a user can easily control peripheral apparatuses coupled to a television.

In an embodiment of the invention, a display apparatus with HDMI-CEC prompt facility comprises a control unit, a display panel, and a HDMI signal processing unit. The control unit is used to receive a control signal from a remote controller. The display panel is controlled by the control unit to display an image. The HDMI signal processing unit is coupled to the control unit and a peripheral apparatus, the peripheral apparatus having the HDMI-CEC prompt facility. When the remote controller controls the peripheral apparatus via the control unit and the HDMI signal processing unit, the image on the display panel shows a set of functional key patterns of the remote controller corresponding to functions to control the peripheral apparatus.

In an embodiment of the invention, the control method with HDMI-CEC prompt facility is used to operate a display apparatus having HDMI-CEC prompt facility. The display apparatus is coupled with a peripheral apparatus. The peripheral apparatus also has HDMI-CEC prompt facility. The control method comprising using a remote controller to control the peripheral apparatus via the display apparatus. The method further comprises using the remote controller to issue an activating signal to activate a HDMI-CEC facility, to cause the display apparatus to display a functional key prompt pattern of the remote controller corresponding to the peripheral apparatus.

In an embodiment of the invention, a control method with HDMI-CEC prompt facility is applied to control a television to select a peripheral apparatus having the HDMI-CEC facility. The control method comprises activating a prompt facility through a special key on a remote controller, wherein the television shows by an OSD menu about a set of control keys of the remote controller supported by the peripheral apparatus with HDMI-CEC facility.

It is to be understood that both the foregoing general descriptions and the following detailed embodiments are exemplary and are, together with the accompanying drawings, intended to provide further explanation of technical features and advantages of the invention.

### BRIEF DESCRIPTION OF THE DRAWINGS

The accompanying drawings are included to provide a further understanding of the invention and are incorporated in and constitute a part of this specification. The drawings illustrate embodiments of the invention and, together with the descriptions, serve to explain the principles of the invention.

FIG. 1 is a schematic view illustrating a conventional audio-visual combo.

FIG. 2 is a schematic view illustrating control of connection between a conventional television with HDMI-CEC prompt facility and peripheral apparatuses.

FIG. 3 is a schematic circuit block diagram illustrating a display apparatus with HDMI-CEC prompt facility according to an embodiment of the invention.

FIG. 4 is a schematic view illustrating key patterns of a remote controller according to an embodiment of the invention.

FIG. 5 is a schematic view illustrating functional key patterns corresponding to functions of a digital STB according to an embodiment of the invention.

FIGS. 6 and 7 are schematic view illustrating displayed key patterns corresponding to different peripheral apparatuses.

FIG. 8 is a schematic flowchart illustrating an operation according to an embodiment of the invention.

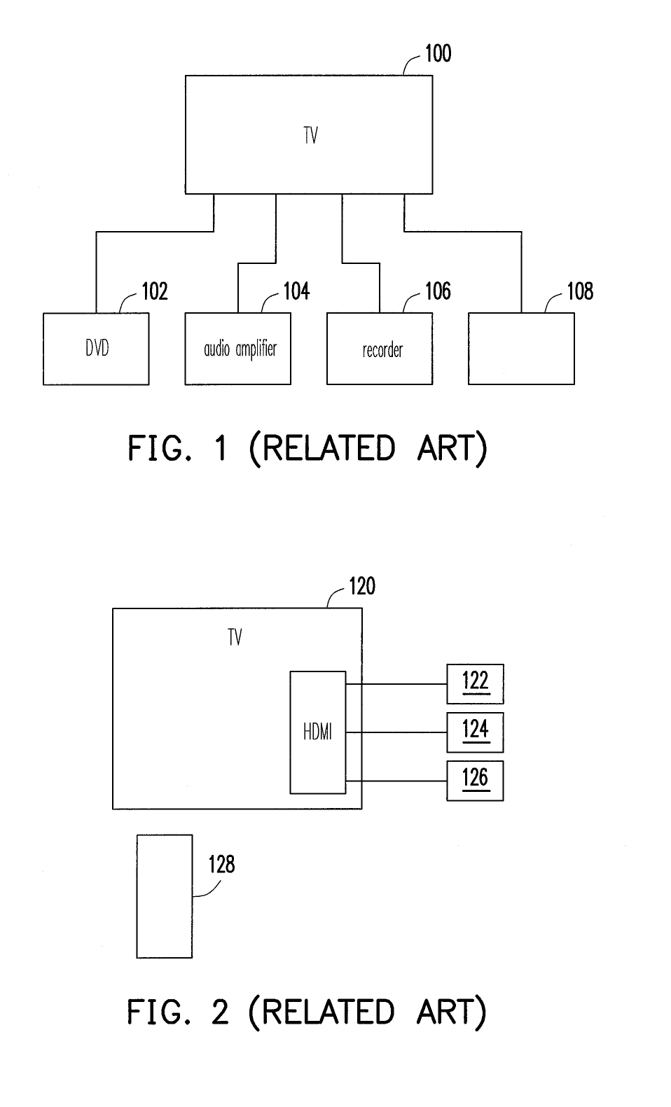

### DESCRIPTION OF EMBODIMENTS

This invention is directed to a control technique of displaying HDMI-CEC prompt facility on a display apparatus. When a user selects to switch from a television to an apparatus having the HDMI-CEC prompt facility, a special key on a remote controller can be pressed to display (in a manner of an OSD) functional keys corresponding to the HDMI-CEC facility of the apparatus controlled by the remote controller, for example. The prompt facility can be set as on or off to facilitate user operation and improve user satisfaction.

Following embodiments of the invention are merely illustrative of certain applications of the principle of the invention but are not intended to limit the invention. Besides, combinations or modifications may be properly made to memory structures and methods described in the embodiment without departing from the spirit and scope of the invention.

According to an embodiment of the invention, when a user selects to switch from the television to a peripheral apparatus coupled to the television, and the peripheral apparatus also has the HDMI-CEC prompt facility, the user can press a special key on a remote controller to receive a message displayed in a matter of an OSD, given the user is not aware of functional keys on the remote controller. The message shows the functional keys corresponding to functions supported by the peripheral apparatus. The peripheral apparatus includes, for example, a DVD player, an audio amplifier, a recorder, or a digital STB, so as to facilitate user operation. The user can choose not to receive the message by shutting off the aforesaid function.

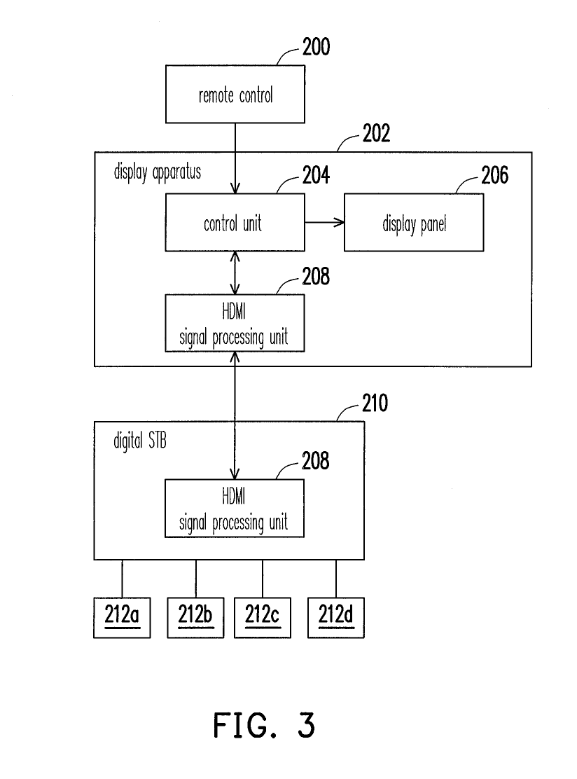

FIG. 3 is a schematic circuit block diagram illustrating a display apparatus with HDMI-CEC prompt facility according to an embodiment of the invention. With reference to FIG. 3, a display apparatus 202 can be controlled by a remote controller 200. The display apparatus 202 is, for example, a television with the HDMI-CEC prompt facility. The display apparatus 202 can be coupled to one or more of the peripheral apparatuses including the DVD player, the audio amplifier, the recorder, or the digital STB 210 at the same time. In this embodiment, the user exemplarily selects to switch from the display apparatus 202 to the digital STB 210. The remote controller 200 controls the digital STB 210 via the display apparatus 202.

The display apparatus 202 has a control unit 204, a display panel 206, and a HDMI signal processing unit 208 disposed therein. The control unit 204 can receive various control signals from the remote controller 200. The display panel 206 is controlled by the control unit 204 to display an image. The HDMI signal processing unit 208 is coupled to the control unit 204 and a peripheral apparatus 210. The peripheral apparatus 210 also has the HDMI signal processing unit 208 which has the HDMI-CEC prompt facility. In this embodiment, the peripheral apparatus 210 refers to the digital STB, for example. The digital STB (the peripheral apparatus 210) can also be coupled to different signal source apparatuses 212a, 212b, 212c, 212d . . . to process various signal sources.

When the remote controller 200 selects to control the peripheral apparatus 210 via the control unit 204 and the HDMI signal processing unit 208, and if the remote controller 200 activates a functional key with prompt facility, an image on the display panel 206 shows a set of functional key patterns corresponding to various functions of the peripheral apparatus 210 controlled by the remote controller 200.

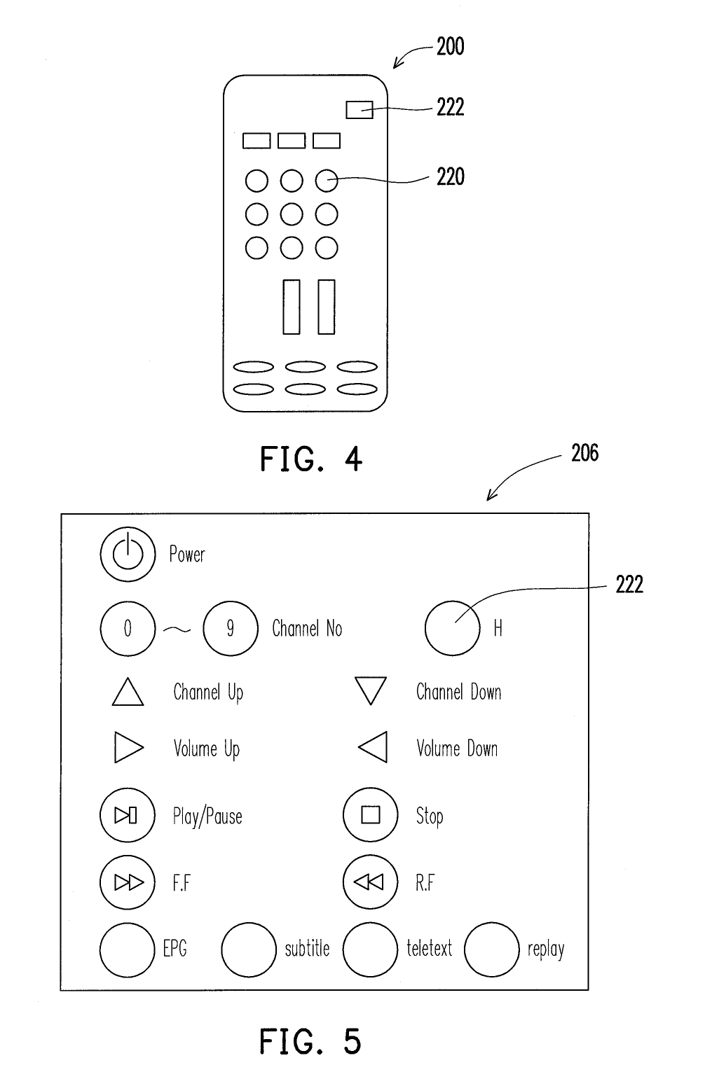

FIG. 4 is a schematic view illustrating key patterns of a remote controller according to an embodiment of the invention. With reference to FIG. 4, various keys 220 on the remote controller 200 correspond to the HDMI-CDE facility to be controlled. However, the remote controller 200 can activate a prompt function by a set of functional key patterns being supported by the remote controller 200 via a special key 222 to control the peripheral apparatus 210.

FIG. 5 is a schematic view illustrating functional key patterns corresponding to functions of a digital STB according to an embodiment of the invention. In FIG. 5, the display panel 206 of the display apparatus 202 partially displays a set of key patterns for the remote controller 200 to control the digital STB.

In an embodiment, when the television 202 is connected with the digital STB 210, the HDMI-CEC can be used for control. When a user uses the remote controller to control the digital STB via the display apparatus, to achieve a remote-control-pass-through function, an OSD prompt message can be displayed on the display panel 206 of the display apparatus 202 by pressing the special key 222 on the remote controller 200, such that the user can learn the functional keys corresponding to the remote-control-pass-through function, which facilitates user operation.

In addition for the embodiment, when the user does not need the prompt function, the special key 222 can be further used to turn off the function.

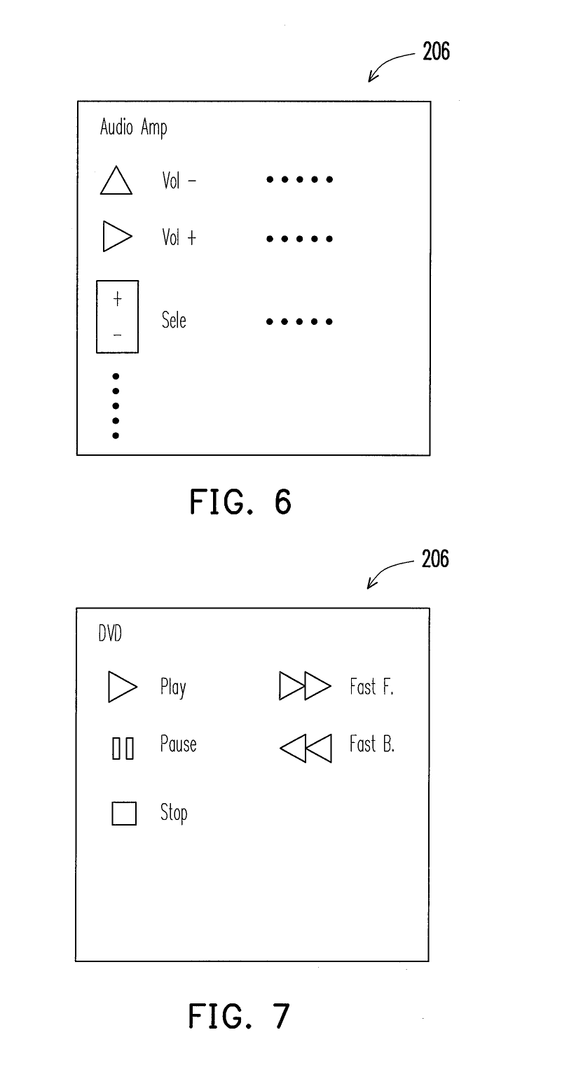

Moreover, when the user switches the display apparatus 202 to other peripheral apparatuses, such as the audio amplifier or the DVD player, the key patterns displayed on the display panel 206 are accordingly changed. FIGS. 6 and 7 are schematic view illustrating displayed key patterns corresponding to different peripheral apparatuses. With reference to FIG. 6, when the user switches the display apparatus 202 to the audio amplifier, for example, the display is the key patterns of the remote controller corresponding to functions to control the audio amplifier. With reference to FIG. 7, when the user switches from the display apparatus 202 to the DVD player, for example, the display is the key patterns of the remote controller corresponding to the functions to control the DVD player.

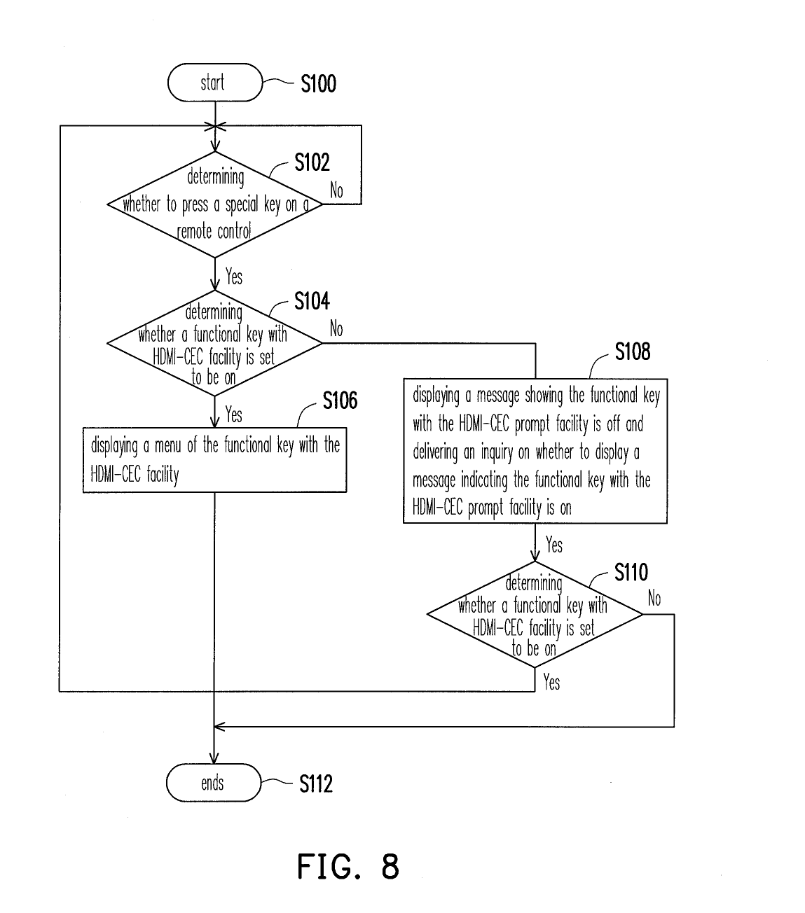

FIG. 8 is a schematic flowchart illustrating an operation according to an embodiment of the invention. See FIG. 8. The operation starts at step S100. In step S102, whether to press a special key on a remote controller is determined. If the special key on the remote controller is not pressed yet, the operation returns to step S102. By contrast, if the special key on the remote controller is already pressed, the operation proceeds to step S104 to determine whether a functional key with HDMI-CEC prompt facility is set to be on. If the functional key with the HDMI-CEC prompt facility is set to be on in step S104, the operation then proceeds to step S106; if the functional key with the HEMI-CEC prompt facility is not set to be on in step S104, the operation then proceeds to step S108. In step S106, a menu of the functional key with the HDMI-CEC prompt facility is displayed, and then the operation ends when it proceeds to step S112. On the other hand, in step S108, a message indicating that the functional key with the HDMI-CEC prompt facility is off is displayed, and an inquiry on whether to activate the display of function keys with the HDMI-CEC prompt facility, for example. If the display is to be activated, the operation proceeds to step S110, namely checking whether display of the functional key with the HDMI-CEC prompt facility is to be set on. If yes, the operation returns to step S102; if not, the operation then ends when it proceeds to step S112.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A display apparatus with HDMI-CEC prompt facility, the display apparatus comprising:
a control unit, used to receive a control signal from a remote controller;
a display panel, controlled by the control unit to display an image; and
a HDMI signal processing unit, coupled to the control unit and a peripheral apparatus, the peripheral apparatus having the HDMI-CEC prompt facility,
wherein when the remote controller controls the peripheral apparatus via the control unit and the HDMI signal processing unit, the image on the display panel shows a set of functional key patterns of the remote controller corresponding to functions to control the peripheral apparatus.

2. The display apparatus as claimed in claim 1, wherein the functional key patterns are used to prompt functional keys with HDMI-CEC facility corresponding to the peripheral apparatus.

3. The display apparatus as claimed in claim 1, further comprising a digital set-top box having HDMI-CEC facility, being coupled to the HDMI signal processing unit.

4. The display apparatus as claimed in claim 1, wherein the peripheral apparatus comprises at least one of a DVD player, an audio amplifier, and a recorder.

5. The display apparatus as claimed in claim 1, wherein the set of functional key patterns is displayed in a manner of an OSD menu.

6. The display apparatus as claimed in claim 1, wherein when the remote controller activates a functional key prompt facility, the image display the functional key patterns.

7. The display apparatus as claimed in claim 6, wherein when the functional key prompt facility is at off state, the image on the display panel displays a message of the off state, and a message for inquiring whether or not activating the functional key prompt facility.

8. A control method with HDMI-CEC prompt facility, used to operate a display apparatus having HDMI-CEC prompt facility, the display apparatus coupled with a peripheral apparatus, the peripheral apparatus also having HDMI-CEC prompt facility, the control method comprising:
using a remote controller to control the peripheral apparatus via the display apparatus; and
using the remote controller to issue an activating signal to activate a HDMI-CEC facility, to cause the display apparatus to display a functional key prompt pattern of the remote controller corresponding to the peripheral apparatus.

9. The control method as claimed in claim 8, wherein the display apparatus displays the functional key prompt pattern by an OSD menu.

10. The control method as claimed in claim 8, wherein the peripheral apparatus comprises at least one of a DVD player, an audio amplifier, and a recorder.

11. The control method as claimed in claim 8, wherein the peripheral apparatus and the display apparatus are coupled to each other via a digital set-top box having the HDMI-CEC facility.

12. The control method as claimed in claim 8, when the HDMI-CEC prompt facility is off,
displaying on the display apparatus by a message to indicate the HDMI-CEC prompt facility is off;
inquiring by a message for whether or not to activate the HDMI-CEC prompt facility; and
activating the HDMI-CEC prompt facility via the remote controller.

13. A control method with HDMI-CEC prompt facility, the control method being applied to control a television to select a peripheral apparatus having the HDMI-CEC facility, the control method comprising:
activating a prompt facility through a special key on a remote controller, wherein the television shows by an OSD menu about a set of control keys of the remote controller supported by the peripheral apparatus with HDMI-CEC facility.

14. The control method as claimed in claim 13, wherein the prompt facility can be set to be on or off.
